(19) United States
(12) Patent Application Publication
(10) Pub. No.: US 2011/0200040 A1
(43) Pub. Date: Aug. 18, 2011

(54) EXTREMUM ROUTE DETERMINING ENGINE AND METHOD

(75) Inventors: Xiao Tao Chang, Beijing (CN); Wei Liu, Beijing (CN); Kun Wang, Beijing (CN); Hong Bo Zeng, Beijing (CN)

(73) Assignee: International Business Machines Corporation, Armonk, NY (US)

(21) Appl. No.: 13/025,225

(22) Filed: Feb. 11, 2011

(30) Foreign Application Priority Data
Feb. 12, 2010 (CN) 201010120196.X

(51) Int. Cl. H04L 12/56

(52) U.S. Cl. 370/389

(57) ABSTRACT

An embodiment of the invention provides an extremum route determining engine and method. The engine includes a memory for storing a path with a weight in a graph and an extremum route determining logic circuit. The logic circuit includes a path reading section for reading the path in the graph, a writing section for updating the weight of the read path according to a predetermined extremum requirement and writing the path whose weight is updated into the memory, and an extremum route determining section for determining an extremum route. The method includes reading a stored path in a graph, the path having a weight, updating the weight of the read path and writing the path whose weight has been updated into a memory, and determining an extremum route. An embodiment of the invention improves the processing speed of extremum route determination.

### CROSS-REFERENCE TO RELATED APPLICATIONS

This application claims priority under 35 U.S.C. §119 to Chinese Patent Application No. 201010120196.X filed Feb. 12, 2010 the entire contents of which are being incorporated herein by reference.

### BACKGROUND OF THE INVENTION

1. Field of the Invention

The present invention relates to route determination in communication, and more specifically, to an extremum route determining engine and method.

2. Description of the Related Art

In the field of communications, it is often needed to determine a shortest route in communication. This is especially true in multicasting routing and physical distribution route optimization with delay constraint. A route refers to a set of a plurality of continuous paths between two communication nodes possibly via intermediate nodes. A path refers to a direct passage between two communication nodes without intermediate nodes. There exists in the prior art a method of determining a shortest route mainly by software, which has a shortcoming that the processing speed of software implementation is slower. For a process that needs a plurality of steps to be performed, software must run respective software modules one by one; thus, processing speed is slower. Hardware can serially connect all the processing steps in a hardware circuit to directly output a result and thus has a faster processing speed. However, there lacks in the prior art knowledge about how to implement shortest route determination by hardware and what kind of existing device can be used for determining the shortest route.

### SUMMARY OF THE INVENTION

An object of an embodiment of the invention is to improve the processing speed of extremum route determination.

In one aspect of the invention, an extremum route determining engine is provided. The extremum route determining engine includes a memory for storing a path with a weight in a graph, and an extremum route determining logic circuit. The extremum route determining logic circuit can include a path reading section for reading the path in the graph, a writing section for updating the weight of the read path according to a predetermined extremum requirement and writing the path whose weight is updated into the memory, and an extremum route determining section for determining an extremum route.

In a second aspect of the invention, an extremum route determining method is provided. The method includes reading a stored path in a graph, the path having a weight. The method further includes updating the weight of the read path and writing the path whose weight has been updated into a memory. Finally, the method also includes determining an extremum route.

An embodiment of the invention improves the processing speed of extremum route determination.

### BRIEF DESCRIPTION OF THE DRAWINGS

FIG. 1 is a block diagram illustrating architecture of a generic regular expression engine according to an embodiment of the present invention.

FIG. 2 is a structural diagram illustrating a best fit scheduling module of the generic regular expression engine according to an embodiment of the present invention.

FIG. 3 illustrates a rule in the generic regular expression engine according to an embodiment of the present invention.

FIG. 4 is a structural diagram illustrating an extremum route determining engine according to an embodiment of the invention according to an embodiment of the present invention.

FIG. 5 illustrates a path according to an embodiment of the invention according to an embodiment of the present invention.

FIG. 6 illustrates an example of a stored graph according to an embodiment of the invention according to an embodiment of the present invention.

FIG. 7 illustrates a path table corresponding to each round of read and write operations according to an embodiment of the invention according to an embodiment of the present invention.

FIG. 8 illustrates an exemplary structure of the writing section in FIG. 4 according to an embodiment of the present invention.

FIG. 9 is a structural diagram illustrating an extremum route determining engine according to another embodiment of the invention according to an embodiment of the present invention.

FIG. 10 is a flowchart illustrating a method according to an aspect of the invention according to an embodiment of the present invention.

### DETAILED DESCRIPTION OF THE PREFERRED EMBODIMENT

A basic idea according to an aspect of the invention is as follows: shortest route determination is implemented mainly by software in the prior art; although it is well known that hardware implementation can improve the processing speed of shortest route determination, there lacks in the prior art knowledge about how to implement shortest route determination by hardware and what kind of existing device can be used for determining the shortest route. The inventors found through long-term research that, the existing extremum route determining method model is similar to some processing rules in the generic regular expression engine. Therefore, by means of the existing generic regular expression engine, only a small amount of improvements are needed for implementing shortest route determination, which fills up blanks in the prior art of the knowledge about how to implement shortest route determination by hardware and what kind of existing device can be used for determining the shortest route, and improves the processing speed of shortest route determination. A detailed description of the invention is made in combination with the following embodiments.

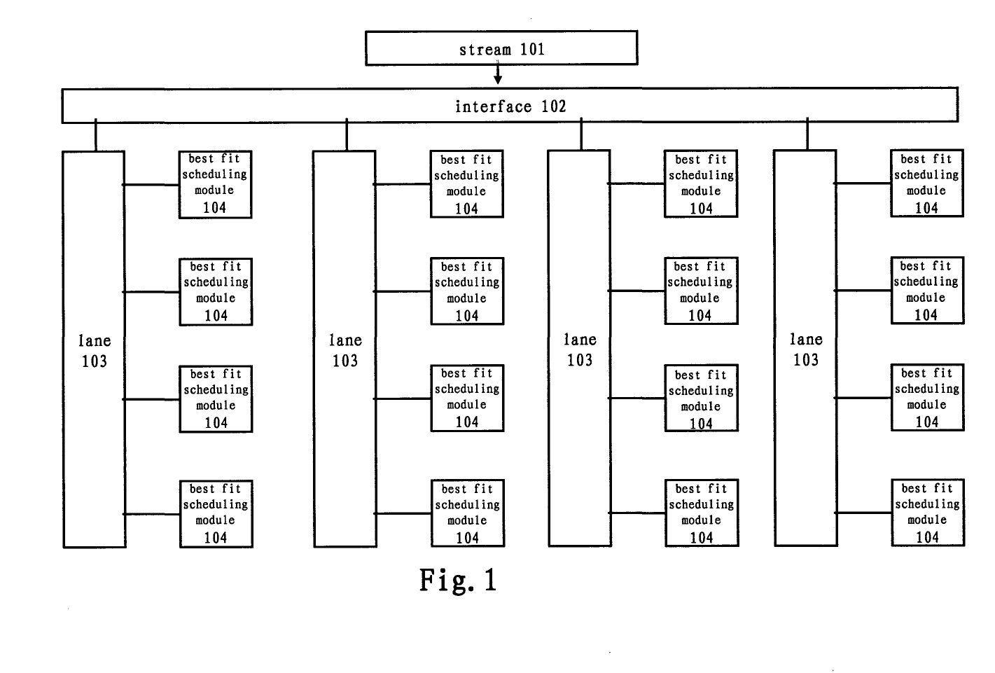

FIG. 1 is a block diagram showing architecture of a generic regular expression engine. One function of the generic regular expression engine is to monitor if there are illegal contents in the network data stream, i.e. performing network security management. Illegal characters possibly appearing in the network data stream are stored in advance as templates in a best fit scheduling module (BFSM) 104. A stream 101 is divided into a plurality of portions via an interface 102, which respectively enter a plurality of lanes 103. The purpose of providing a plurality of lanes 103 is for parallel operation to thereby improve processing efficiency. Each lane 103 is attached with a plurality of BFSMs 104. Templates of illegal characters possibly appearing are individually stored in the plurality of BFSMs 104 attached to each lane 103 for parallel operation, thereby improving processing efficiency.

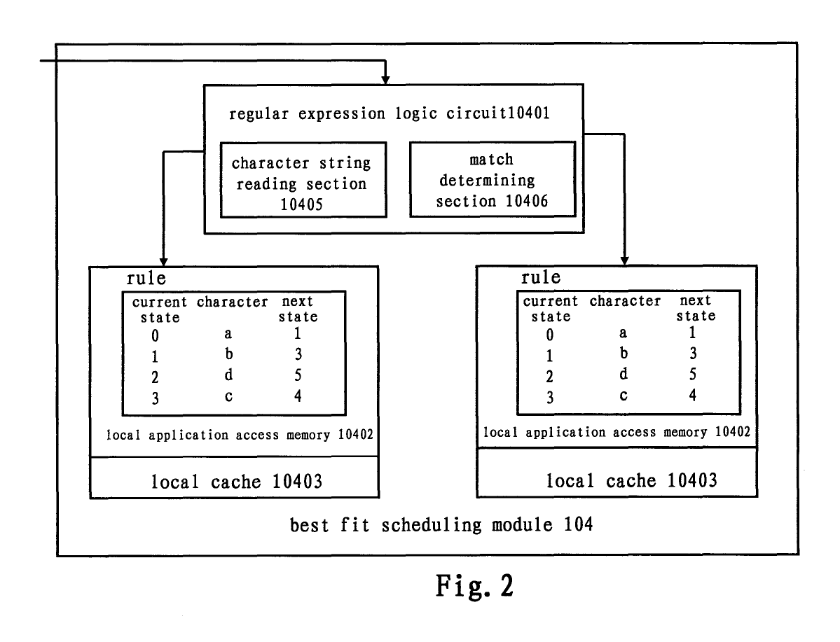

FIG. 2 is a structural diagram showing a best fit scheduling module 104 of the generic regular expression engine. BFSM 104 includes a regular expression logic circuit 10401, a local application access memory 10402, and a local cache 10403. A rule table comprising templates of illegal characters possibly appearing is stored in the local application access memory 10402. Templates often used in the process can be stored in the local cache 10403. The regular expression logic circuit 10401 comprises a character string reading section 10405 and a match determining section 10406.

For example, it is wanted to monitor if there is an illegal character string “abc” in the stream 101. The stream 101 enters one of the lanes 103 via the interface 102. All the BFSMs 104 attached to the lane co-operate with each other to check whether or not characters entering the lane match with a rule stored therein.

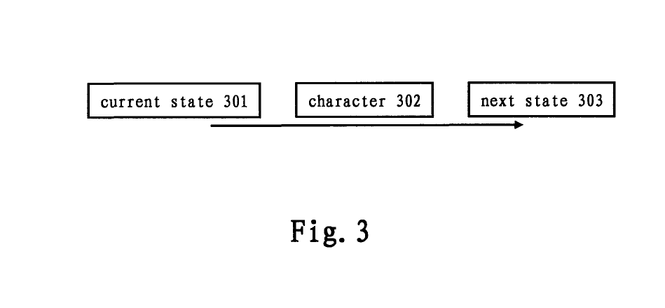

FIG. 3 shows a rule in the generic regular expression engine. The character 302 is set in the current state 301, and then a next state 303 is generated. Assuming that the initial state set in the system is 0, the current state of the system is 0.

The character “a” in the stream 101 first enters a lane 103. The character string reading section 10405 searches in a rule table in the local application access memory 10402. Since the current state is 0 and the character is “a”, a rule of “0-a-1” is found. The character string reading section 10405 reads the rule and thus knows that the next state is 1.

Subsequently, the character “b” in the stream 101 enters the lane. The character string reading section 10405 searches in the rule table in the local application access memory 10402. The next state in the just read rule becomes the current state, so the current state is “1”. Since the character entering the lane is “b”, a rule of “1-b-3” is found. The character sting reading section 10405 reads the rule and thus knows that the next state is “3”.

Subsequently, the character “c” in the stream 101 enters the lane. The character string reading section 10405 searches in the rule table in the local application access memory 10402. The next state in the just read rule becomes the current state, so the current state is “3”. Since the character entering the lane is “c”, a rule of “3-c-4” is found. The character sting reading section 10405 reads the rule and thus knows that the next state is “4”.

The match determining circuit 10406 sets a reference value 4. The next state is equal to the reference value “4”, which means that the stream 101 contains an illegal character string “abc”. The regular expression engine alarms.

In the generic regular expression engine, there are the character string reading section 10405 and the match determining section 10406 for reading a character string and determining match, respectively, thereby identifying an illegal character string; extremum route determination generally also comprises processes of reading a path in a graph and determining an extremum route between two points. In addition, the generic regular expression engine has the following rules: using the character as a transition from the current state to the next state; when determining the extremum route, each route in the graph being also regarded as a weight as a transition from the current node to a next node. Therefore, extremum route determination is very similar to match identification in the generic regular expression engine. The extremum route determining engine according to an embodiment of the invention completely can make a simple improvement on the existing structure of the generic regular expression engine, to thereby improve the processing speed of the extremum route determination with a low cost.

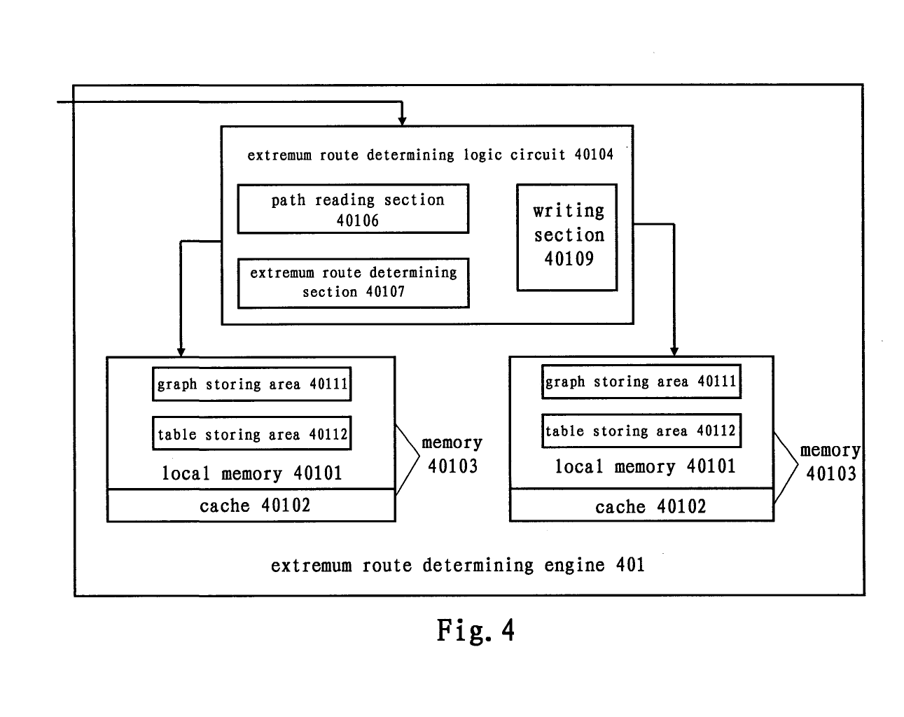

FIG. 4 is a structural diagram showing an extremum route determining engine 401 according to an embodiment of the invention. The extremum route determining engine 401 comprises an extremum route determining logic circuit 40104, and a memory 40103. The memory 40103 comprises a local memory 40101 and a cache 40102. The local memory 40101 comprises a graph storing area and a table storing area 40112. The extremum route determining logic circuit 40104 comprises a path reading section 40106, an extremum route determining section 40107 and a writing section 40109.

Although FIG. 4 illustratively shows two memories 40103, it is apparent to those skilled in the art that, a single memory, or three or more memories can also be used for implementing the storing function in the invention.

The local memory 40101 adopts the local application access memory 10402 in the generic regular expression engine. The cache 40102 adopts the local cache 10403 in the generic regular expression engine. The path reading section 40106 adopts the character string reading section 10405 in the generic regular expression engine, and changes the corresponding character string reading section into the path reading function to be described in detail below. The extremum route determining section 40107 adopts the match determining section 10406 in the generic regular expression engine, and changes the corresponding match determining function into the extremum route determining function to be described in detail below. Therefore, through making improvement on the basis of the generic regular expression engine and adding a writing section 40109, an embodiment of the invention is implemented.

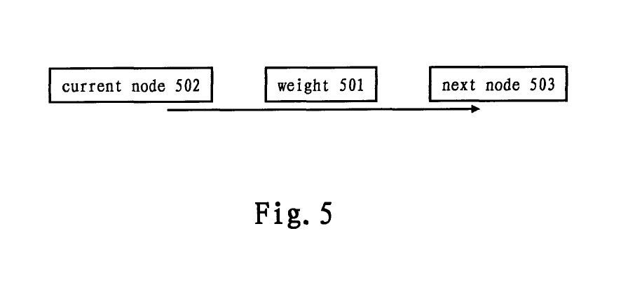

The rule in FIG. 3 is modified to form the concept of path shown in FIG. 5. The path shown in FIG. 5 differs from the rule in FIG. 3 in replacing the character 302 with a weight 501, wherein the current node 502 and the next node 503 in FIG. 5 respectively correspond to the current state 301 and the next state 303 in FIG. 3. The weight 501 represents a distance, or transfer cost, or transfer time, or the like between the current node and the next node. For example, if the function of the extremum route determining engine is to find a route with a shortest transfer distance between two points, then the weight represents the distance between the current node and the next node; if the function of the extremum route determining engine is to find a route with a shortest transfer time between two points, then the weight represents the transfer time between the current node and the next node, and so on.

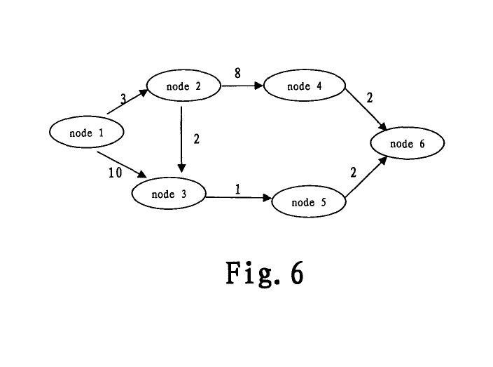

A graph is stored in advance in the graph storing area 40111 in FIG. 4. FIG. 6 shows an example of a stored graph according to an embodiment of the invention. In the embodiment, the path reading section 40106 reads a path from the graph according to Breadth-first. The rule of Breadth-first is as follows: after reading a path starting from a start node, not continuing to read a next path along the path but reading other paths starting from the start node; if all the paths starting from the start node have been read, reading a path starting from an end point of the read first path; and so on. According to this rule, the order of reading paths from the graph in FIG. 6 is as follows:

1) 1-(3)->2

2) 1-(10)->3

3) 2-(8)->4

4) 2-(2)->3

5) 3-(1)->5

6) 4-(2)->6

7) 5-(2)->6.

By taking the first path for example, “1-(3)->2” represents that, the current node is 1, the weight is 3, and the next node is 1.

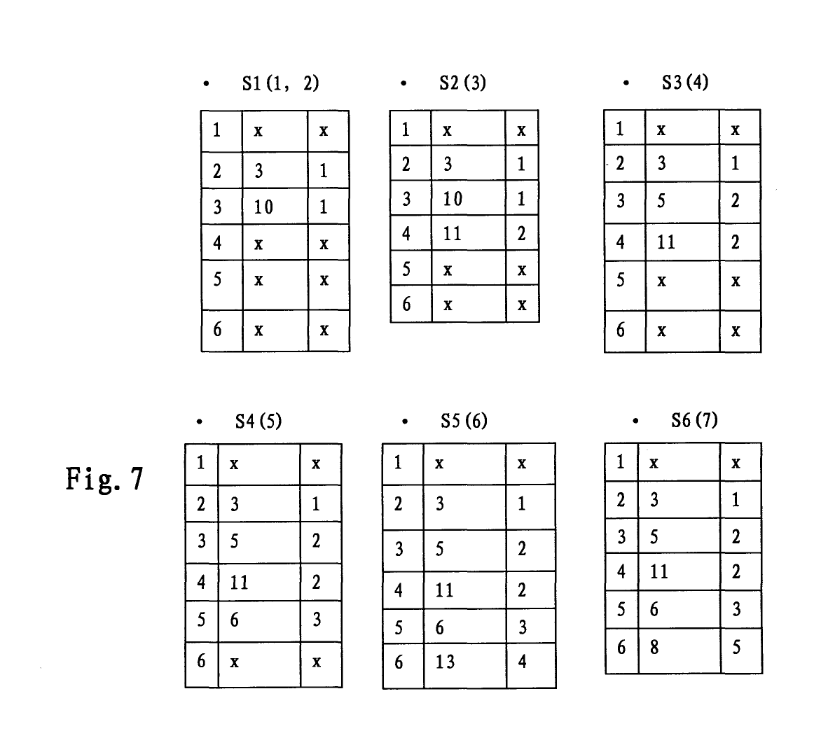

FIG. 7 shows a path table corresponding to each round of read and write operations according to an embodiment of the invention. The path table is stored in the table storing area 40112.

The extremum path determining engine 401 shown in FIG. 4 has a similar operating environment to FIG. 1. The extremum route determining engine 401 is equivalent to the best fit scheduling module 104 in FIG. 1. The stream 101 is replaced with a clock pulse sequence.

After the first clock pulse enters the extremum path determining engine 401 via the interface 102, the path reading section 40106 reads the first path “1-(3)->2” from the graph stored in the graph storing area. The writing section 40109 judges whether or not there stores in the path table a path including the current node, the weight and the previous node in a line corresponding to the current node 1 in the path. If a result of the judgment is “No”, no processing is made. Then it is judged whether or not there stores a path including the current node, the weight and the previous node in a line corresponding to the next node 2 in the first path. If a result of the judgment is “No”, the first path is written into the line corresponding to the node 2. As shown in Table S(1, 2) of FIG. 7, the weight 3 and the previous node 1 are written into the line corresponding to the node 2.

As another embodiment, the path table in FIG. 7 can be organized in a manner that each column corresponds to a written path. In this case, the above-described “line” is replaced with “column”. In the specification, “line” and “column” are collectively referred to as addresses. In the following text, although “line” is described, it is apparent to those skilled in the art that, the following described “line” can also be replaced with “column”.

Subsequently, the second clock pulse enters the extremum path determining engine 401. The path reading section 40106 reads the second path “1-(10)->3” from the graph stored in the graph storing area. The writing section 40109 judges whether or not there stores in the path table a path including the current node, the weight and the previous node in a line corresponding to the current node 1 in the path. If a result of the judgment is “No”, no processing is made. Then it is judged whether or not there stores a path including the current node, the weight and the previous node in a line corresponding to the next node 3 in the second path. If a result of the judgment is “No”, the second path is written into the line corresponding to the node 3. As shown in Table S1(1, 2) of FIG. 7, the weight 10 and the previous node 1 are written into the line corresponding to the node 3.

The Table S1(1,2) is a path table that is written in response to the first and second clock pulses. Of course, a path table written in response to the first clock pulse and a path table written in response to the second clock pulse can be shown respectively.

In the present embodiment, the path reading section 40106 reads a path from the graph in response to receipt of a clock pulse. However, it is known to those skilled in the art that, as another embodiment, the path reading section 40106 can read two or more paths from the graph in response to receipt of two or more clock pulses. As another embodiment, the path reading section 40106 can read one path from the graph in response to receipt of two or more clock pulses.

Subsequently, the third clock pulse enters the extremum path determining engine 401. The path reading section 40106 reads the third path “2-(8)->4” from the graph stored in the graph storing area. The writing section 40109 judges whether or not there stores in the path table a complete path including the current node, the weight and the previous node in a line corresponding to the current node 2 in the path. If a result of the judgment is “Yes”, the weight 8 of the read third path is added to the weight 3 of the path in the line corresponding to the node 2. Then, the weight of the third path becomes 11, which shows that the weight from the node 1 to the node 4 is 11. Then it is judged whether or not there stores a complete path including the current node, the weight and the previous node in a line corresponding to the next node 4 in the third path. If a result of the judgment is “No”, the third path is written into the line corresponding to the node 4. As shown in Table S2(3) of FIG. 7, the weight 11 and the previous node 2 are written into the line corresponding to the node 4.

Subsequently, the fourth clock pulse enters the extremum path determining engine 401. The path reading section 40106 reads the fourth path “2-(2)->3” from the graph stored in the graph storing area. The writing section 40109 judges whether or not there stores in the path table a complete path including the current node, the weight and the previous node in a line corresponding to the current node 2 in the path. If a result of the judgment is “Yes”, the weight 2 of the read fourth path is added to the weight 3 of the path in the line corresponding to the node 2. Then, the weight of the fourth path becomes 5, which shows that the weight from the node 2 to the node 3 is 5. Then it is judged whether or not there stores a complete path including the current node, the weight and the previous node in a line corresponding to the next node 3 in the fourth path. If a result of the judgment is “Yes”, the weight 10 in the line corresponding to the node 3 is compared with the weight 5 of the fourth path. Since 5 is less than 10, the fourth path is written into the line corresponding to the node 3. As shown in Table S3(4) of FIG. 7, the weight 5 and the previous node 2 are written into the line corresponding to the node 3.

Subsequently, the fifth clock pulse enters the extremum path determining engine 401. The path reading section 40106 reads the fifth path “3-(1)->5” from the graph stored in the graph storing area. The writing section 40109 judges whether or not there stores in the path table a complete path including the current node, the weight and the previous node in a line corresponding to the current node 3 in the path. If a result of the judgment is “Yes”, the weight 1 of the read fifth path is added to the weight 5 of the path in the line corresponding to the node 3. Then, the weight of the fifth path becomes 6, which shows that the weight from the node 3 to the node 5 is 6. Then it is judged whether or not there stores a complete path including the current node, the weight and the previous node in a line corresponding to the next node 5 in the fifth path. If a result of the judgment is “No”, the fifth path is written into the line corresponding to the node 5. As shown in Table S4(5) of FIG. 7, the weight 6 and the previous node 3 are written into the line corresponding to the node 5.

Subsequently, the six clock pulse enters the extremum path determining engine 401. The path reading section 40106 reads the sixth path “4-(2)->6” from the graph stored in the graph storing area. The writing section 40109 judges whether or not there stores in the path table a complete path including the current node, the weight and the previous node in a line corresponding to the current node 4 in the path. If a result of the judgment is “Yes”, the weight 2 of the read six path is added to the weight 11 of the path in the line corresponding to the node 4. Then, the weight of the sixth path becomes 13, which shows that the weight from the node 4 to the node 6 is 13. Then it is judged whether or not there stores a complete path including the current node, the weight and the previous node in a line corresponding to the next node 6 in the six path. If a result of the judgment is “No”, the sixth path is written into the line corresponding to the node 6. As shown in Table S5(6) of FIG. 7, the weight 13 and the previous node 4 are written into the line corresponding to the node 6.

Subsequently, the seventh clock pulse enters the extremum path determining engine 401. The path reading section 40106 reads the seventh path “5-(2)->6” from the graph stored in the graph storing area. The writing section 40109 judges whether or not there stores in the path table a complete path including the current node, the weight and the previous node in a line corresponding to the current node 5 in the path. If a result of the judgment is “Yes”, the weight 2 of the read seventh path is added to the weight 6 of the path in the line corresponding to the node 5. Then, the weight of the seventh path becomes 8, which shows that the weight from the node 5 to the node 6 is 8. Then it is judged whether or not there stores a complete path including the current node, the weight and the previous node in a line corresponding to the next node 6 in the seventh path. If a result of the judgment is “Yes”, the weight 13 in the line corresponding to the node 6 is compared with the weight 8 of the seventh path. Since 8 is less than 13, the seventh path is written into the line corresponding to the node 6. As shown in Table S6(7) of FIG. 7, the weight 8 and the previous node 5 are written into the line corresponding to the node 6.

Since the writing section 40109 writes all the paths in the graph, the extremum route determining section 40107 determines an extremum route according to the path table S6(7) stored in the memory. For example, the shortest route between the node 1 and the node 4 is determined as follows: in the Table S6(7), the previous node in the path stored in the line corresponding to the node 4 is 2, the previous node in the path stored in the line corresponding to the node 2 is 1, so the shortest route between the node 1 and the node 4 is 1-2-4. Again for example, the shortest route between the node 1 and the node 6 is determined as follows: in the Table S6(7), the previous node in the path stored in the line corresponding to the node 6 is 5, the previous node in the path stored in the line corresponding to the node 5 is 3, the previous node in the path stored in the line corresponding to the node 3 is 2, and the previous node in the path stored in the line corresponding to the node 2 is 1, so the shortest route between the node 1 and the node 6 is 1-2-3-5-6.

The shortest route between two nodes can be determined as above. According to another embodiment of the invention, a longest route between two nodes can also be determined. The shortest route and the longest route are collectively referred to extremum route. In a scenario where a longest route between two nodes shall be determined, e.g. in order to release upgraded software between two nodes, it requires that the upgraded software is obtained by as many as nodes between the two nodes. The method of determining the longest route between two nodes differs from the method of determining the shortest route between two nodes in that, if there stores a path in a line corresponding to a next node in the read path, the writing section compares the weight in the read path to the weight in the path stored in the line corresponding to the next node, and writes the larger rather than the smaller into the line corresponding to the next node. Still by taking the process from S2(3) to S3(4) for example, after comparing the weight 10 in the line corresponding to the node 3 to the weight 5 of the fourth path, since 5 is less than 10, the line corresponding to the node 3 is not changed. That is, in the line corresponding to the node 3, the weight still is 10, and the weight of the previous node is still 1.

For the convenience of search, the Tables S(1,2)-S6(7) in FIG. 7 all can be stored in the table storing area 40112. However, in another embodiment, in order to save space, only the final Table S6(7) is stored, because the extremum route can be determined only from the Table S6(7).

In the above embodiment, only the extremum route from the node 1 to other nodes can be determined from the Table S6(7). However, in another embodiment, path tables starting from the node 2, the node 3 and etc. can be made. In this way, an extremum route between any two nodes in the graph can be determined from the stored route tables.

In the above embodiment, the table S6(7) is made in advance and is stored in the table storing area 40112. However, in another embodiment, the table is made not in advance but in response to a request from the user to calculate an extremum route between two nodes. Therefore, after receiving the user's inputs regarding a start point and an end point, it is needed to perform the processes of path reading, writing and extremum route determining similar to S1(1,2) through S6(7) in FIG. 7. In this way, storage space can be decreased but real-time response is reduced.

Furthermore, in another embodiment, only a part of the tables in FIG. 7 may be made, for example, if requests to inquire about extremum routes starting from the node 1 and the node 2 are more frequently issued, tables regarding the node 1 and the node 2 may be made in advance and are stored in the table storing area 40112, and the table for the extremum route starting from the node 3, 4, 5 or 6 is not saved.

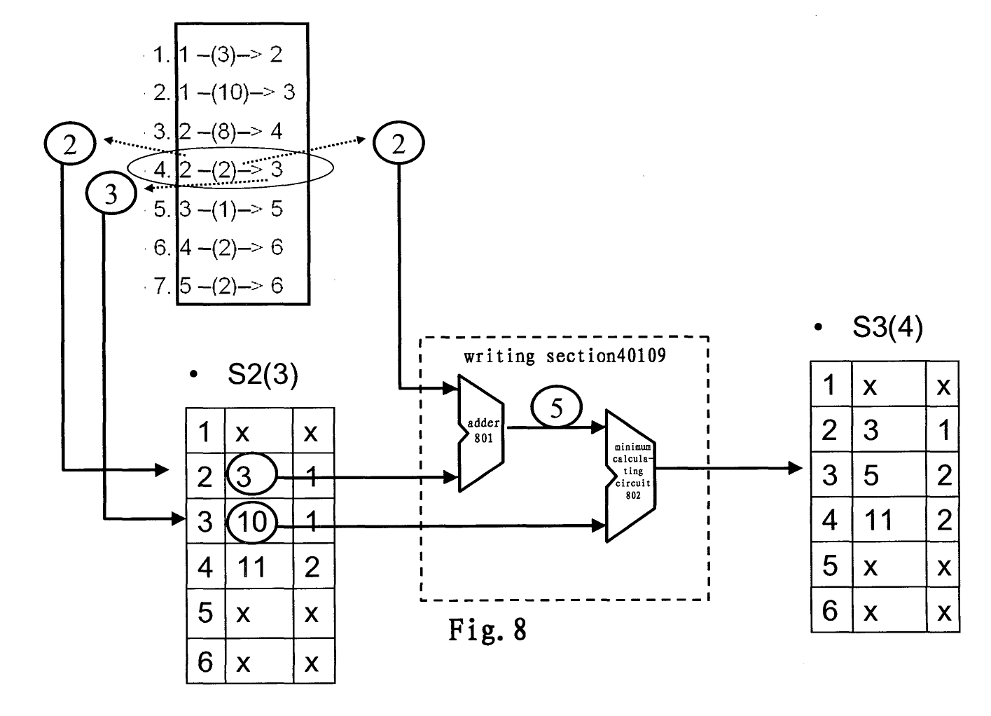

FIG. 8 shows an exemplary structure of the writing section 40109 in FIG. 4. The writing section 40109 comprises an adder 801 and a minimum calculating circuit 802. FIG. 8 shows a process for updating the Table S2(3) to S3(4) by using the adder 801 and the minimum calculating circuit 802. The currently read path is 2-(2)-→3. The current node 2 and the next node 3 respectively are enabling signals of weights corresponding to the nodes 2 and 3 in the output path table. The current node 2 enables the path table such that the path table outputs the weight 3 corresponding to the node 2. The weight 3 along with the weight 2 of the currently read path is inputted to the adder 801 and a sum 5 is outputted. Meanwhile, the current node 3 enables the path table such that the path table outputs the weight 10 corresponding to the node 3. The sum 5 and the weight 10 are inputted to the minimum calculating circuit 802. The output of the minimum calculating circuit 802 is 5. The outputted weight 5 and the previous node 2 are written into the line corresponding to the node 3 in the path table.

It can be apparently seen from FIG. 8 that, since the calculating steps in FIG. 8 are implemented by serially connected hardware, after reading a path, the minimum calculating circuit 802 will generate an output result immediately, and writes it into the path table, and the whole process only needs a clock cycle. If like the prior art, all the calculating steps are implemented by software, each step needs waiting for the result of the previous step, which greatly increases the processing time. For example, in FIG. 8, it is needed to firstly execute the reading operation, then execute the addition operation, and then calculate the minimum, wherein the calculation of the minimum needs waiting for the result of the addition operation. Since software is executed step by step, the operation of the current step relies on the result of the operation of the previous step, so in order to wait for the operation of the previous step, a plurality of clock cycles are needed, which is decided by the features of software and hardware implementation.

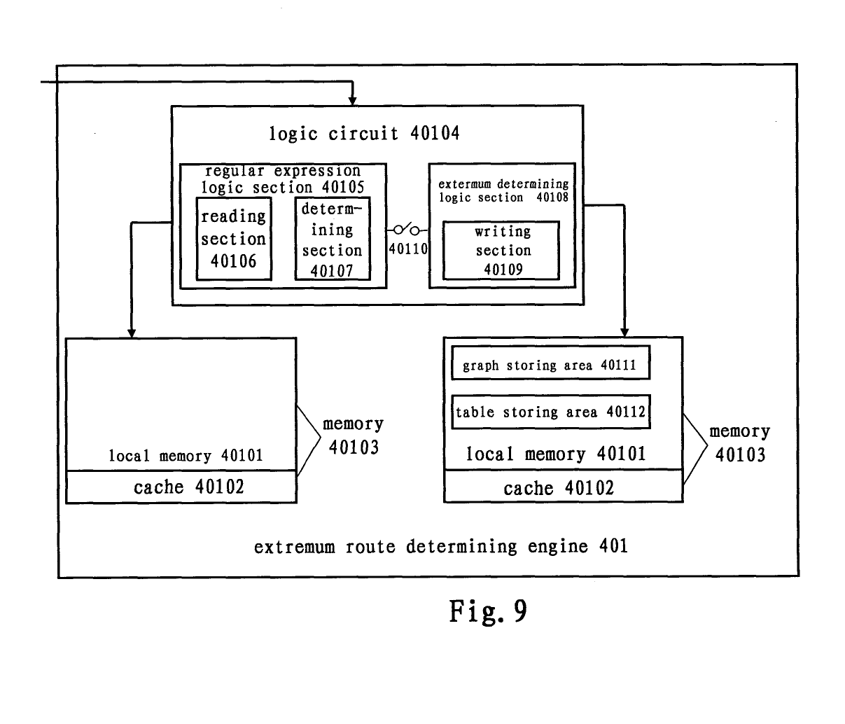

FIG. 9 is a structural diagram showing an extremum route determining engine according to another embodiment of the invention. The embodiment differs from the above-described embodiment in that, the extremum route determining logic circuit 40104 comprises a switch 40110 for selectively enabling the writing section 40109. When the switch 40110 is switched off, the writing section 40109 does not operate. The path reading section 40106 operates as the character string reading section 10405 in FIG. 2, and the extremum route determining section 40107 operates as the match determining section 10406 in FIG. 2. The combination of them with the memory 40103 is equivalent to the best fit scheduling module 104 in FIG. 2, for performing the best fit scheduling function in the generic regular expression engine. When the switch 40110 is switched off, the writing section 40109 operates. The path reading section 40106, the extremum route determining section 40107, the writing section 40109 and the memory 40103 cooperate with each other for determining the extremum route. In this way, the extremum route determining engine according to the embodiment can operate flexibly. If it is not needed for determining the extremum route, it can operate as a part of the generic regular expression engine, which increases flexibility of application. Other portions of the embodiment are similar to those of the above-described embodiment.

According to another embodiment, the path reading section 40106 reads a path from the graph according to Depth-first rather than Breadth-first. The rule of Depth first is as follows: after reading a path starting from any node, continuing to read a subsequent path of the path until no path can be read; if no subsequently path can be read, re-determining from the previous node of the path if other un-read paths can be read along the previous node.

According to this rule, the order of reading a path from the graph in FIG. 6 is as follows:

1) 1-(3)-→2

2) 2-(8)-→4

3) 4-(2)-→6

4) 2-(2)-→3

5) 3-(1)-→5

6) 5-(2)-→6

7) 1-(10)-→3

It can be seen that, if starting from the node 1, passing nodes 2, 4, finally arriving at node 6 and finding no subsequent paths, come back to node 4 to consider if there are other subsequent paths; since there are no subsequent paths starting from the node 4, come back to the node 2 to obtain three paths from the node 2, via nodes 3, 5, finally to the node 6; finally come back to the node 1 to obtain a path from the node 1 to the node 3.

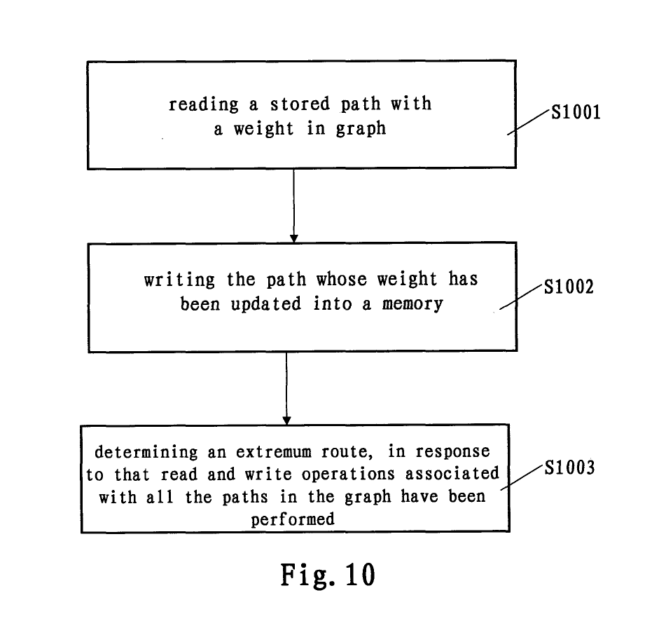

As shown in FIG. 10, the extremum route determining method according to an embodiment of the invention comprises: a step S1001 of reading a stored path in the graph, said path having a weight; a step S1002 of updating the weight of the read path and writing the path whose weight is updated into a memory; and a step S1003 of determining an extremum value.

The writing section 40109 according to an embodiment of the invention can be implemented by hardware in FIG. 8, and the path reading section 40106 and the extremum route determining section 40107 can be implemented by software programming on the basis of the character string reading section 10405 and the match determining section 10406 in FIG. 2. Software implementation can take the form of an entirely software embodiment (including firmware, resident software, microcode, etc.) or an embodiment combining software and hardware aspects that may all generally be referred to herein as a “circuit,” “module” or “system.” Furthermore, software improvement of the present invention can take the form of a computer program product embodied in any tangible medium of expression having computer usable program code embodied therein.

Any combination of one or more computer usable or computer readable medium(s) can be utilized to perform software parts of an embodiment of this invention. The computer usable or computer readable medium can be, for example, but not confined to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium supporting for example the Internet or Intranet, or a magnetic storage device. Note that the computer usable or computer readable medium even can be paper or other suitable medium on which programs are printed, and this is because the programs can be obtained electronically by electrically scanning the paper or other medium, and then be compiled, interpreted or processed appropriately, and be stored in a computer memory if necessary. In the context of this document, a computer usable or computer readable storage medium can be any medium that contains, stores, communicates, propagates, or transmits a program for use by or in connection with an instruction execution system, apparatus, or device. A computer useable medium can include a data signal with computer usable program code embodied therein, propagated in baseband or as part of a carrier wave. The computer usable program code can be transmitted using any appropriate medium, including but not confined to wireless, wireline, optical fiber cable, RF, etc.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the computer or other programmable data processing apparatus, create means for implementing the functions/acts specified in the blocks of the flowchart illustrations and/or block diagrams.

These computer program instructions can also be stored in a computer readable medium that can direct a computer or other programmable data processing apparatus to function in a particular manner, such that the instructions stored in the computer readable medium produce an article of manufacture including instruction means which implement the functions/acts specified in the blocks of the flowchart illustrations and/or block diagrams.

The computer program instructions can also be loaded onto a computer or other programmable data processing apparatus to cause a series of operational steps to be performed on the computer or other programmable data processing apparatus to produce a computer implemented process such that the instructions which execute on the computer or other programmable apparatus provide processes for implementing the functions/acts specified in the blocks of the flowchart illustrations and/or block diagrams.

The flowchart illustrations and block diagrams in the figures illustrate the architecture, functionality, and operation of possible implementations of systems, methods and computer program products according to various embodiments of the present invention. In this regard, each block in the flowchart illustrations or block diagrams can represent a module, program segment, or portion of code, which comprises one or more executable instructions for implementing the specified logical function(s). It should also be noted that, in some alternative implementations, the functions noted in the blocks can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be confining of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

What is claimed is:

1. An extremum route determining engine, comprising:
a memory for storing a path with a weight in a graph; and
an extremum route determining logic circuit comprising:
a path reading section for reading the path in the graph;
a writing section for updating the weight of the read path according to a predetermined extremum requirement and writing the path whose weight is updated into the memory; and
an extremum route determining section for determining an extremum route.

2. An extremum route determining engine according to claim 1, wherein the memory adopts the memory in a generic regular expression engine, the path reading section adopts a character string reading section in the generic regular expression engine, and the extremum route determining section adopts a match determining section in the generic regular expression engine.

3. An extremum route determining engine according to claim 1, wherein the path further comprises a current node and a next node.

4. An extremum route determining engine according to claim 3, wherein, if there is stored a complete path at an address of the current node in the read path, the writing section updates the weight of the read path by adding thereto the weight at the address of the current node; and if there is not stored a complete path at an address of the current node in the read path, the writing section does not process.

5. An extremum route determining engine according to claim 4, wherein, if there is not stored a complete path at an address of the next node in the read path, the writing section writes the read path into the address of the next node.

6. An extremum route determining engine according to claim 4, wherein, if there is stored a complete path at an address of the next node in the read path, the writing section compares the weight of the read path with the weight of the path stored at the address of the next node and writes the smaller into the address of the next node.

7. An extremum route determining engine according to claim 4, wherein, if there is stored a complete path at an address of the next node in the read path, the writing section compares the weight of the read path with the weight of the path stored at the address of the next node and writes the larger into the address of the next node.

8. An extremum route determining engine according to claim 1, wherein the path reading section reads a path from the graph according to one of the following algorithms:
Breadth-first and Depth-first.

9. An extremum route determining engine according to claim 1, wherein the extremum route determining logic circuit comprises a switch, for selectively enabling the writing section.

10. An extremum route determining engine according to claim 1, wherein the writing section comprises an adder and a minimal calculating circuit.

11. An extremum route determining engine according to claim 1, wherein, in response to that the writing section writes all the paths in the graph, the extremum route determining section determines the extremum route.

12. An extremum route determining method, comprising:
reading a stored path in a graph, the path having a weight;
updating the weight of the read path and writing the path whose weight has been updated into a memory; and
determining an extremum route.

13. An extremum route determining method according to claim 12, wherein the path further comprises a current node and a next node.

14. An extremum route determining method according to claim 13, wherein if there is stored a complete path at an address of the current node in the read path, updating the weight of the read path by adding thereto the weight at the address of the current node; and if there is not stored a complete path at an address of the current node in the read path, not processing.

15. An extremum route determining method according to claim 14, wherein if there is not stored a complete path at an address of the next node in the read path, writing the read path into the address of the next node.

16. An extremum route determining method according to claim 14, wherein if there is stored a complete path at an address of the next node in the read path, comparing the weight of the read path with the weight of the path stored at the address of the next node and writing the smaller into the address of the next node.

17. An extremum route determining method according to claim 14, wherein if there is stored a complete path at an address of the next node in the read path, comparing the weight of the read path with the weight of the path stored at the address of the next node and writing the larger into the address of the next node.

18. An extremum route determining method according to claim 12, wherein the path is read from the graph according to one of the following algorithms:
Breadth-first and Depth-first.

19. An extremum route determining method according to claim 12, further comprising: selectively enabling the writing.

20. An extremum route determining method according to claim 12, further comprising: in response to that all the paths in the graph are written, determining the extremum route.
